(19) United States
(12) Patent Application Publication
(10) Pub. No.: US 2018/0140127 A1
(43) Pub. Date: May 24, 2018

(54) DIFFUSER FOR BEVERAGES

(71) Applicant: INTERCON TRADER LTD., TAIPEI (TW)

(72) Inventors: YUAN-HUEI LIN, TAIPEI (TW); HAN-KE LIU, TAIPEI (TW)

(21) Appl. No.: 15/468,107

(22) Filed: Mar. 23, 2017

(30) Foreign Application Priority Data
Nov. 24, 2016 (TW) 105217971

(51) Int. Cl. A47J 31/06; A47J 31/44

(52) U.S. Cl. CPC A47J 31/0626; A47J 31/4407

(57) ABSTRACT

A diffuser for beverages has a container, a cover, a diffuser body and a diffuser cover. The container has a bottom portion and a circular sidewall to form a containment space with a main opening. The cover has an assembly opening, and the cover is removably attached onto the container and covering the main opening. The assembly opening of the cover is provided with a flange, the flange divides the assembly opening into an upper portion and lower a portion, and at least two channels disposed on each side of the flange connecting the upper and lower portions. Furthermore, the diffuser body comprises a first cup body and a second cup body. The diffuser body is further provided with through apertures and filters, and at least two support wings protruding from an outer edge of the diffuser body and aligned with the channel of the cover.

### BACKGROUND OF INVENTION

### 1. Field of Invention

The present invention relates to a diffuser, and more particularly to a diffuser for coffee.

### 2. Description of Related Art

The conventional coffee brewing device usually has a container, the container can be a teapot or a cup, and the container has a filter. When water is added into the container, built-in filter with coffee powder is placed into its internal space through the opening of the container and stay on the opening of the container, so that the water in the container is able to pass through the filter hole to soak the coffee powder in the filter can be soaked completely.

However, the above conventional structure still has following problems exist: the coffee powder is continuously soaked in the container, so that the remaining coffee liquid gradually becomes hitter. In order to prevent the coffee powder from being soaked for too long, the filter with the coffee powder needs to be removed from the container, but the removal movement is more inconvenient and trouble. In addition, while removing the filter might cause coffee stain around.

Therefore, it is desirable to provide a diffuser for beverages to mitigate and/or obviate the aforementioned problems.

### SUMMARY OF INVENTION

An objective of present invention is to provide a diffuser for beverages.

In order to achieve the above mentioned objective, a diffuser for beverages comprises a container, a cover, a diffuser body and a diffuser cover. The container has a bottom portion and a circular sidewall to form a containment space with a main opening. The cover has an assembly opening, and the cover is removably attached onto the container and covering the main opening. The assembly opening of the cover is provided with a flange, the flange divides the assembly opening into an upper portion and lower a portion, and at least two channels disposed on each side of the flange connecting the upper and lower portions. Furthermore, the diffuser body comprises a first cup body and a second cup body. The diffuser body is further provided with through apertures and filters, and at least two support wings protruding from an outer edge of the diffuser body and aligned with the channel of the cover. When the diffuser body is placed into the containment space of the container through the assembly opening of the cover, the flange of the cover is capable of engaging with the first cup body of the diffuser body. The diffuser cover is further provided with a driving portion and a ring, the diffuser cover is removably attached onto the cover, the assembly opening of the cover is covered by the diffuser cover, and the ring engages with an inner edge of the diffuser body to assemble the diffuser cover and the diffuser body together.

Other objects, advantages, and novel features of invention will become more apparent from the following detailed description when taken in conjunction with the accompanying drawings.

### BRIEF DESCRIPTION OF DRAWINGS

FIG. 1 is a perspective drawing of a preferred embodiment according to the present invention.

FIG. 2 is an exploded drawing of preferred embodiment according to the present invention.

FIG. 3 is a cross-sectional drawing of the preferred embodiment according to the present invention.

FIG. 4 is a schematic drawing showing a diffusion process according to the present invention.

FIG. 5 shows the diffuser cover driving the diffuser body to move upwardly according to the present invention.

FIG. 6 shows the diffuser cover driving the diffuser body to rotate according to the present invention.

FIG. 7 shows the diffuser body being lifted up according to the present invention.

### DETAILED DESCRIPTION OF PREFERRED EMBODIMENT

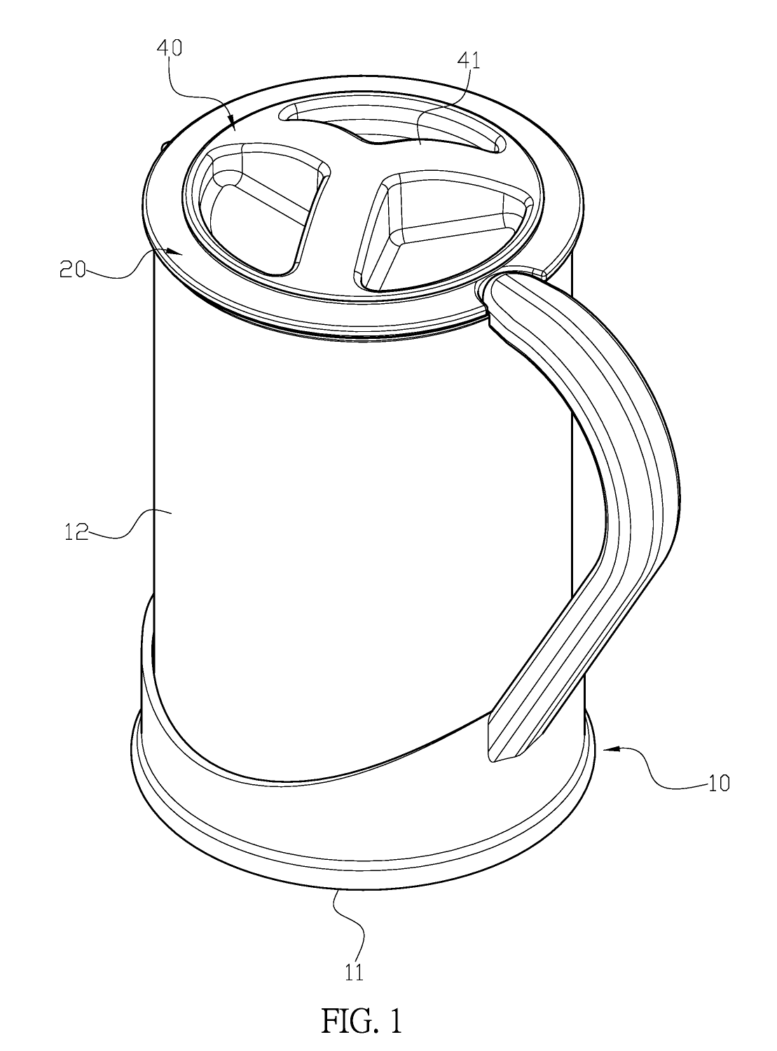

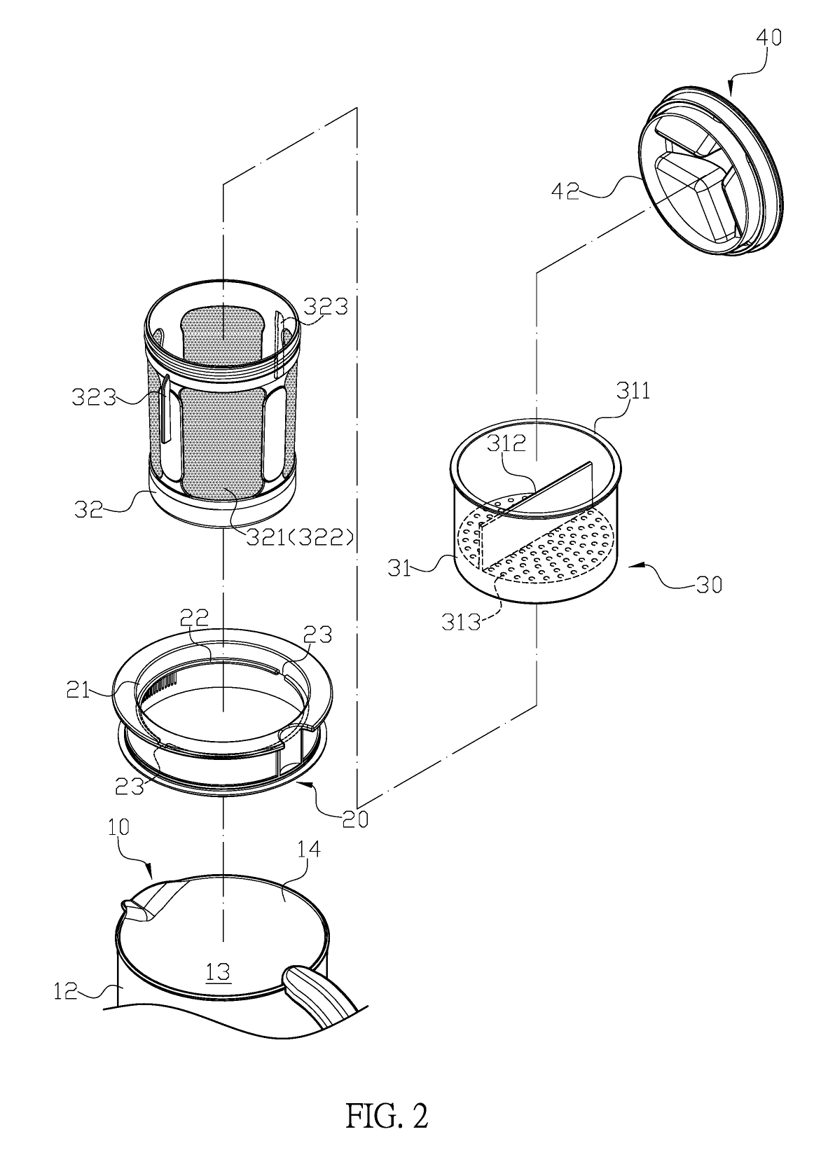

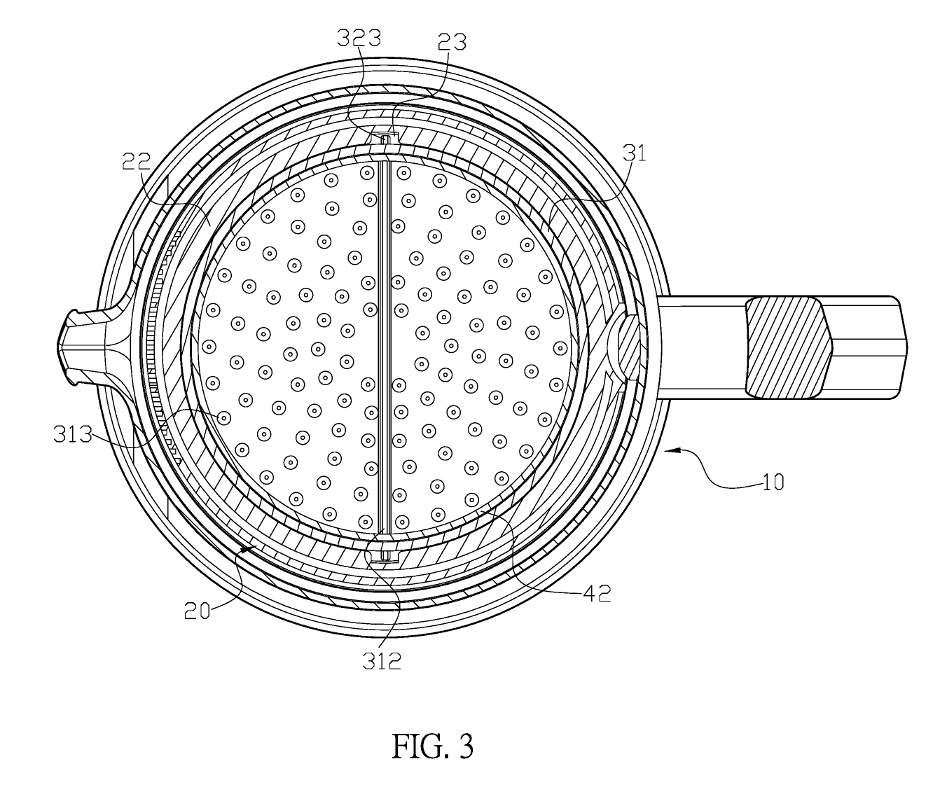

Please refer to FIG. 1 to FIG. 3. A diffuser for beverages comprises a container 10, a cover 20, a diffuser body 30 and a diffuser cover 40. The container 10 has a bottom portion 11 and a circular sidewall 12 to form a containment space 13 with a main opening 14. The cover 20 has an assembly opening 21, and the cover 20 is removably attached onto the container 20 and covering the main opening 14. The assembly opening 21 of the cover 20 is provided with a flange 22, the flange 22 divides the assembly opening 21 into an upper portion and lower a portion, and at least two channels 23 disposed on each side of the flange 22 connecting the upper and lower portions. Furthermore, the diffuser body comprises a first cup body 31 and a second cup body 32. The diffuser body 30 is further provided with through apertures 321 and filters 322, and at least two support wings 322 protruding from an outer edge of the diffuser body 30 and aligned with the channel 23 of the cover 20. When the diffuser body 30 is placed into the containment space 13 of the container 10 through the assembly opening 21 of the cover 20, the flange 22 of the cover 20 is capable of engaging with the first cup body 31 of the diffuser body 30. The diffuser cover 40 is further provided with a driving portion 41 and a ring 42, the diffuser cover 40 is removably attached onto the cover 20, the assembly opening 21 of the cover 20 is covered by the diffuser cover 40, and the ring 42 engages with an inner edge of the diffuser body 31 to assemble the diffuser cover 40 and the diffuser body 30 together.

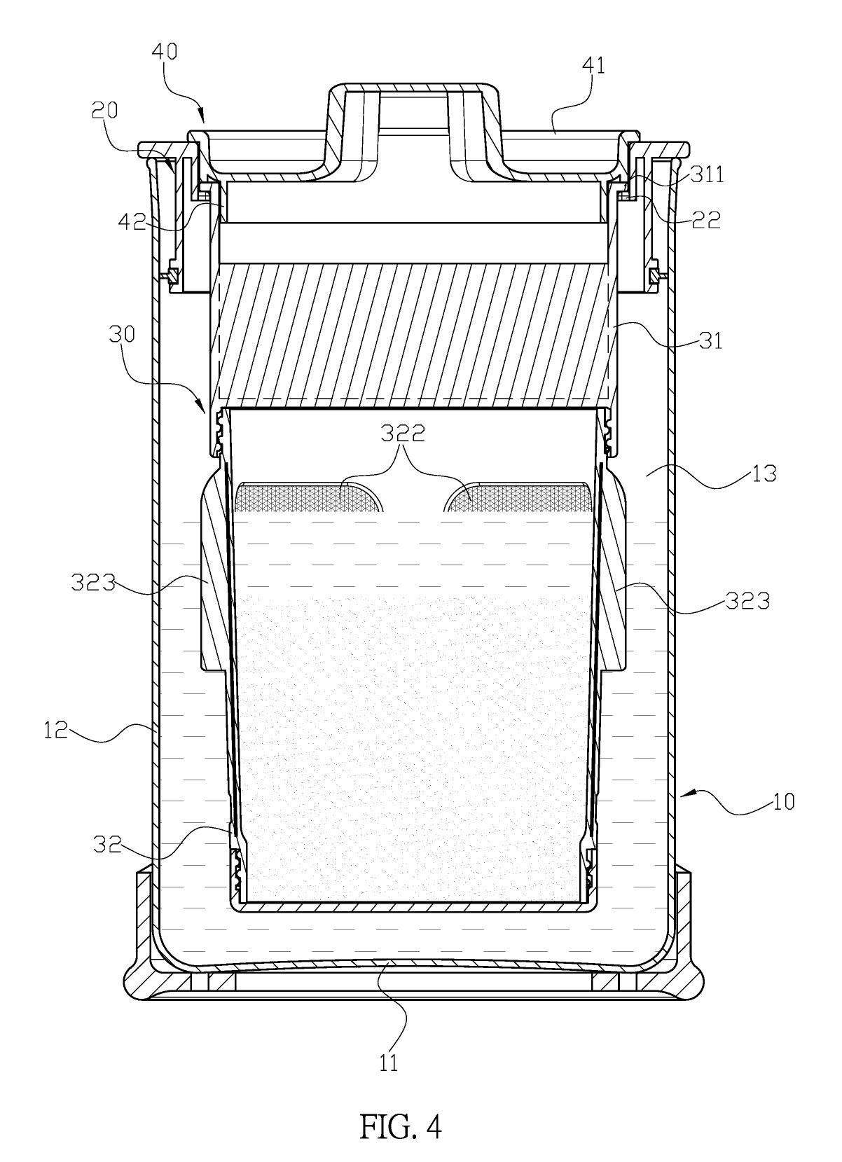

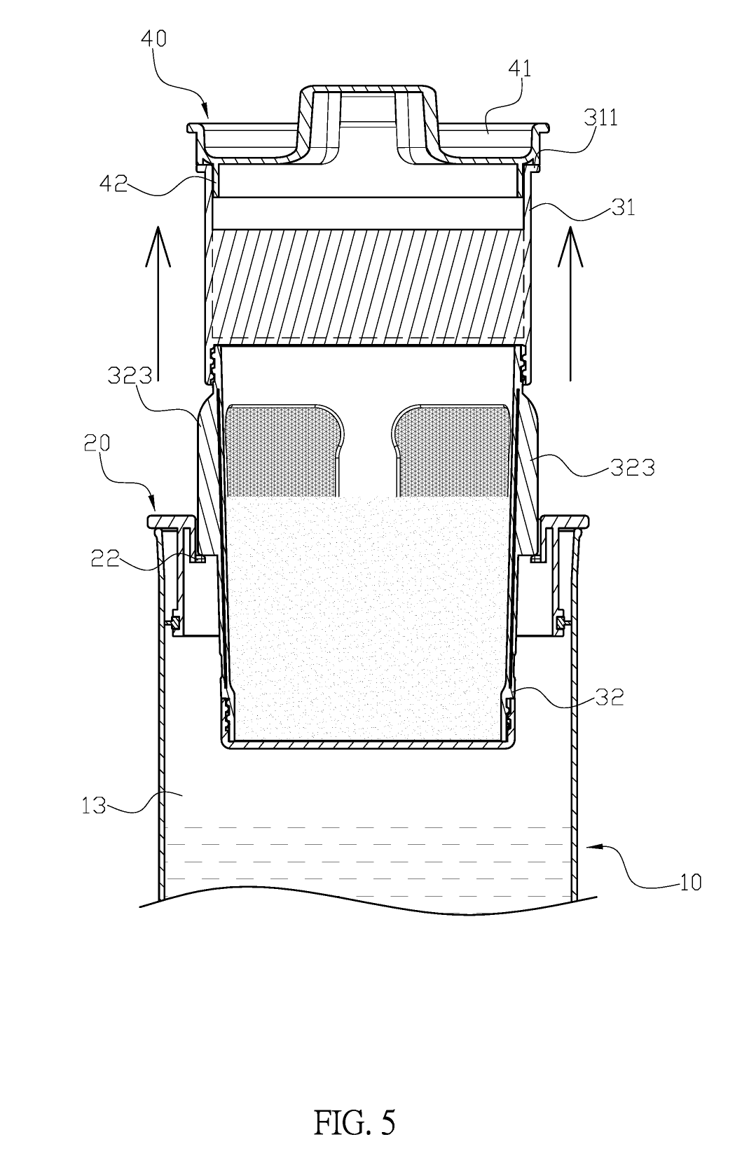

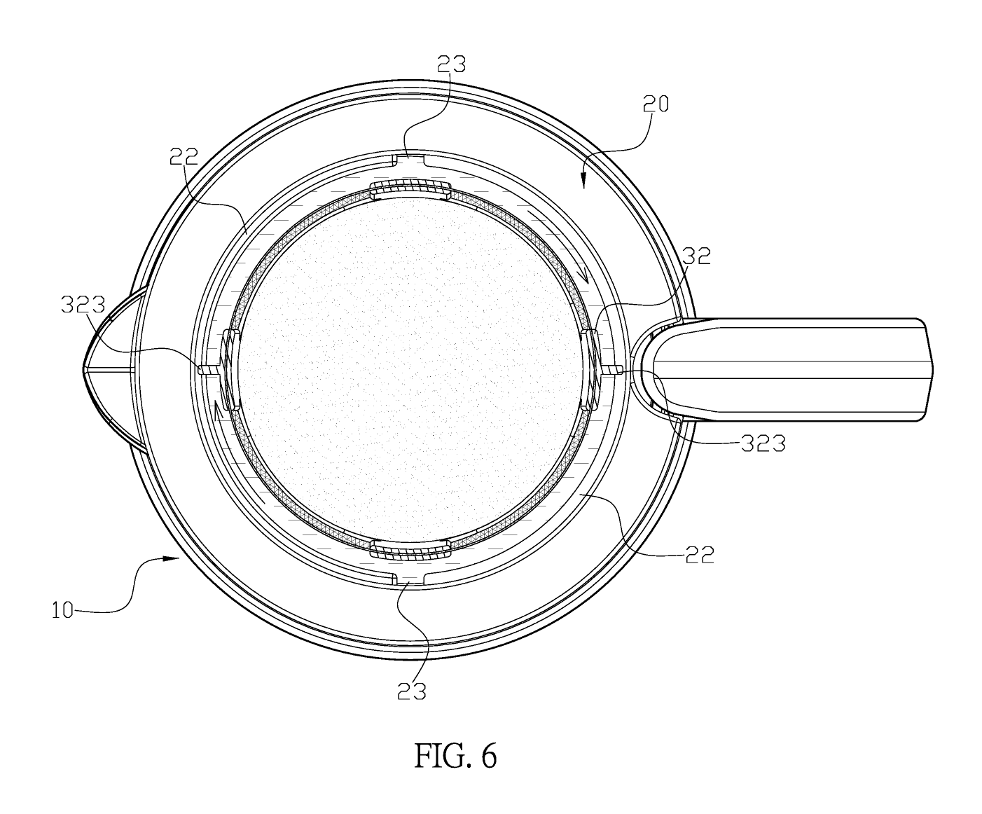

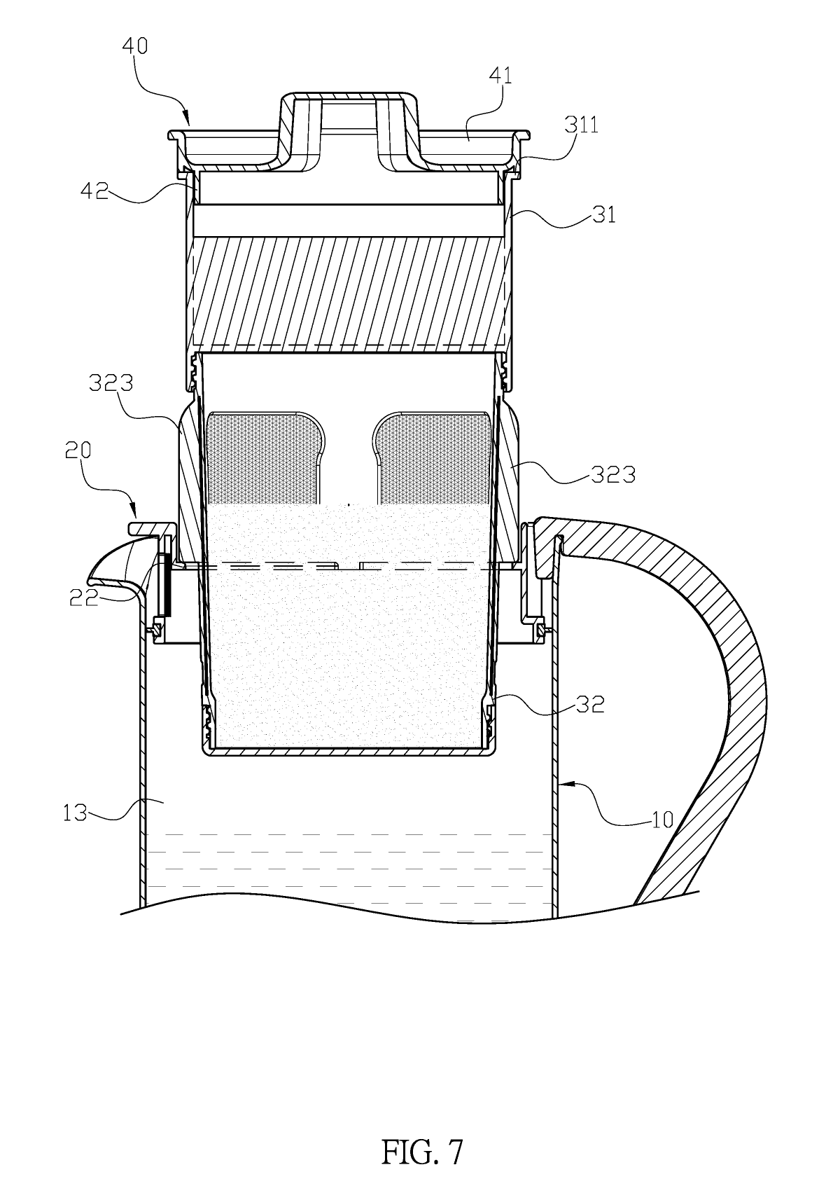

For actual operation, before water is pulled into the containment space 13 of the container 10, the diffuser body 30 loaded with coffee powder is placed into the container 10 through the assembly opening 21 of the cover 20 such that the coffee powder in the second cup body 32 is capable of soaking in the water, as shown in FIG. 4. After a preferred period of soaking time, with the positions of the support wings 323 and the channel 23, the diffuser cover 40 is pulled upwardly to bring the diffuser body 30 together, as shown in FIG. 5. Therefore, the support wings 323 of the diffuser body 30 moves above the flange 22, and the diffuser cover 40 turns the diffuser body 30, as shown in FIG. 6, to make the support wings 323 and the channel 23 being separated apart. Furthermore, the flange 22 supports the bottom of the support wings 323, as shown in FIG. 7, such that the coffee residue in the diffuser body 30 is prevented from soaking too long and causing bitterness. In addition, since the diffuser body 30 is lifted up and stays in the container 10, no coffee stain will spill.

Moreover, the container 10 is a teapot and transparent. Also, engagement between the first cup body 31 and the second cup body 32 is executed by a screw locking method. The first cup body 31 is further provided with a lip 311 configured for contacting with the flange 22 of the cover 20 such that the diffuser body 30 is capable of engaging with the cover 20. The first cup body 31 further includes at least one divider 312. The first cup body 31 is further provided with a plurality of through holes 313 on a bottom face, which allow the liquid to enter into the second cup body 32.

Although the present invention has been explained in relation to its preferred embodiment, it is to be understood that many other possible modifications and variations can be made without departing from the spirit and scope of invention as hereinafter claimed.

What is claimed is:

1. A diffuser for beverages comprising: a container, a cover, a diffuser body and a diffuser cover, the container having a bottom portion and a circular sidewall to form a containment space with a main opening; the cover having an assembly opening, and the cover removably attached onto the container and covering the main opening; the diffuser characterized in that:
the assembly opening of the cover is provided with a flange, the flange dividing the assembly opening into an upper portion and lower a portion, and at least two channels disposed on a side of the flange connecting the upper and lower portions; the diffuser body further provided with through apertures and filters, and at least two support wings protruding from an outer edge of the diffuser body and aligned with the channel of the cover; wherein when the diffuser body is placed into the containment space of the container through the assembly opening of the cover, the flange of the cover is capable of engaging with the diffuser body; and wherein the diffuser cover is further provided with a driving portion and a ring, the diffuser cover removably attached onto the cover, the assembly opening of the cover covered by the diffuser cover, and the ring engaging with an inner edge of the diffuser body.

2. The diffuser for beverages as claimed in claim 1, wherein the container is a tea pot.

3. The diffuser for beverages as claimed in claim 1, wherein the container is transparent.

4. The diffuser for beverages as claimed in claim 1, wherein the diffuser body comprises a first cup body and a second cup body, and the through apertures, the filter, and the support wings are disposed on the second cup body; wherein when the diffuser body is placed into the containment space of the container through the assembly opening of the cover, the flange of the cover hooks with a top end of the first cup body, and the ring of the diffuser cover engages with an inner edge of the first cup body.

5. The diffuser for beverages as claimed in claim 4, wherein engagement between the first cup body and the second cup body is executed by a screw locking method.

6. The diffuser for beverages as claimed in claim 4, wherein the first cup body is further provided with a lip configured for contacting with the flange of the cover such that the diffuser body is capable of engaging with the cover.

7. The diffuser for beverages as claimed in claim 4, wherein the first cup body further includes at least one divider.

8. The diffuser for beverages as claimed in claim 4, wherein the first cup body is further provided with a plurality of through holes on a bottom face.
